(19) United States
(12) Patent Application Publication
(10) Pub. No.: US 2007/0160953 A1
(43) Pub. Date: Jul. 12, 2007

(54) Method for manufacturing a prosthesis made prior to implant placement

(76) Inventor: Philippe Tardieu, La Tronche (FR)

Correspondence Address: CLARK & ELBING LLP, 101 FEDERAL STREET, BOSTON, MA, 02110, US

(21) Appl. No.: 10/596,124

(22) PCT Filed: Nov. 26, 2004
(86) PCT No.: PCT/EP04/13435

§ 371 Date: May 31, 2006

(30) Foreign Application Priority Data
Dec. 1, 2003 (GB) 0327822.3

(51) Int. Cl. A61C 8/00

(52) U.S. Cl. 433/173

(57) ABSTRACT

A dental implant-to-prosthesis interface is provided, allowing lateral misalignments between the fixture heads and the connections to the prosthesis. This type of interface, in combination with a dedicated screw for fixing implant to prosthesis, allows the use of a truly pre-manufactured prosthesis for immediate loading on the implant. This system is particularly suited for cases with multiple implant placement.

### FIELD OF THE INVENTION

The present invention relates to the design of a dental implant/prosthesis interface allowing the pre-operative fabrication of a prosthesis in the dental lab which can be attached to the jaw immediately subsequent to implant placement. It further relates to a method and the means to manufacture a prosthesis.

### BACKGROUND

A typical dental implant assembly can be described as consisting of two portions. The first portion (the fixture) acts as an artificial tooth root and is placed in a cavity that has been prepared in the alveolar bone. The second portion, known as an abutment can be regarded as an intermediate component between the fixture and the prosthesis. It extends beyond the gingival tissue and secures the prosthesis to the implant. In most cases the fixture and the abutment are manufactured as separate components. They are attached to one another by means of a screw that fits into an axially threaded bore common to both the fixture and the abutment. In addition, the interface between the implant and the abutment is configured as a tongue and groove fitting. The surface of the base of the abutment is complementary to the proximal end (the head) of the fixture and the configuration is intended to prevent rotation and to provide tactile feedback when indexing the abutment to the implant. This interface configuration however is only necessary and used for single tooth replacement or small partially edentuous cases where rotation can cause problems.

In a common embodiment of configuration a hexagon protrudes from the proximal end of the fixture and is received in a hexagonal recess in the base of the abutment. Alternatively the male element can be associated with the abutment.

Other mechanical interlock designs have been mentioned, for example by Branjnovic (WO03061512).

For entire bridge replacements or large edentulous cases, the interface between implant and abutment is based on the screw connection. Though the fixture head does have a protusion, there is no interlocking with the base of the abutment. Rotation is prevented inherently by means of the (arch-shaped) implant configuration.

According to a conventional method for attaching a prosthesis to the jaw, implants are placed in the jaw and are left to grow in for a period of two to six months. After this osseo-integration, an impression is taken with copings, which contains all information about the exact position and orientation of the implants. With this impression, the dental laboratory then manufactures the superstructure with the accompanying teeth e.g. the prosthesis.

Recently, however, there is a tendency to refrain from letting the implants grow in for three to six months. Instead they are loaded shortly after placement (e.g. immediate loading). Typically the impression mentioned above is taken immediately subsequent to the implant placement and transferred to the dental lab which makes a temporary or definitive prosthesis, allowing it to be placed on the implants within a week after the implant placement. Ideally however, the prosthesis is manufactured entirely prior to the surgical intervention and placed without the slightest of post-operative delays. This way of working implies that the positions of the implants are known in advance and accurately transferred to the intra-oral situation (for the actual implant placement). Both can be achieved by making use of a known technique involving CT (computer tomography) based implant planning (using dedicated software such as SimPlant™ as supplied by Materialise N.V., Leuven, Belgium) and templates for drill guidance during preparation of the implant cavities.

As mentioned in patent application WO03071972 the accuracy of transferring a planning to the patient can be augmented additionally by means of dedicated systems that also allow guided implant placement. Submillimetre accuracies are thus obtained at the proximal end of the implant when comparing the actual implant placement to the planned implant position. Angular deviations are also reduced.

Despite the improvement this way of working offers with respect to control over the implant's positions, orientations and depths, the accuracy is still too small to allow immediate anchorage of a pre-manufactured prosthesis.

Because the prosthesis is manufactured in the dental lab exactly according to the implant planning, misalignments can be expected between the relative positions of the fixture heads with respect to the anchorage points provided by the prosthesis. In the past temporary implant retained prostheses for immediate loading have been manufactured entirely of acrylic resin (Cooper L. F. et al., 2002, Intern J Oral Maxillofacial Implants 17(14):517-525, 2002) or based on carbon-reinforced technology. To account for misalignments, the prostheses have holes where anchorage to the fixtures is expected. After implant placement, metal cylinders are placed on the fixtures. Next, the cylinders are indexed with the prosthesis. Since, the diameter of the holes in the prosthesis is larger than the diameter of the metal cylinders, misalignments can be corrected. Once the prothesis is in its desired position in the mouth, the temporary cylinders are cemented within the holes using autopolymerizing resin. This procedure is known as relining.

WO 03/003933 describes a method for manufacturing a metal, implant retained suprastructure prior to surgical intervention by means of rapid prototyping techniques such as CNC-milling. No mention however is made of how to adjust for deviations or misalignments between implant planning and actual placement. A possible solution requires forcing the implants into positions corresponding to the anchorage points provided in the pre-manufactured prosthesis. This however implies loading of the implants (both axially and laterally) and causes stresses in the bone around the implants due to anchorage of the prosthesis. The effects of such stressing immediately after implant placement are insufficiently known. In addition there is an increased risk of implant loosening and possibly implant failure if anchorage of the prosthesis is unsuccessful.

Other systems have been described (WO01/95825) in which an attachable coping—as part of a two piece abutment—carries the dental prosthesis and is mounted on the base as a ball-and-socket joint, which permits the dental prosthesis to be aligned. WO00/02495 describes attachment parts that can be fitted to the prosthesis by means of a joint with a conically tapered part wedging mechanical interaction with a corresponding recess in the implant and a bendable part to achieve a common insertion direction for the dental prosthesis arrangement.

Furthermore dedicated alignment correctors have been suggested (U.S. Pat. No. 4,988,297; U.S. Pat. No. 4,907,969) to interconnect implants and prosthesis inserts.

### SUMMARY OF THE INVENTION

The present invention provides a dental implant-to-prosthesis interface, allowing lateral misalignments between the fixture heads and the connections to the prosthesis. This type of interface, in combination with a dedicated screw for fixing implant to prosthesis, allowing the use of a truly premanufactured prosthesis for immediate loading on the implant. This system is particularly suited for cases with multiple implant placement. The invention further relates to dedicated components for use in combination with this type of interface.

A first aspect of the invention relates to a combination of dedicated implant, prosthesis and retaining screw, wherein the anchorage part (1) of the prosthesis comprises a hole (2) for the retaining screw, whereby the diameter of the neck (3) of the retaining screw is smaller than the hole in the anchorage part of the prosthesis. This tolerance of the diameter of the neck of the retaining screw with regard to the opening in the prosthesis allows, upon fixing of the prosthesis to the implant or implant assembly with the retaining screw, compensation for lateral misalignments between the center of the anchorage part of the prosthesis and the center of the implant or implant assembly. According to a particular embodiment the diameter of the neck (3) of the retaining screw is about 0.4 to 1.2 mm smaller with respect to the diameter of hole (2) in the anchorage part of the prosthesis. The difference with fitting tolerances in traditional systems lies in the magnitude of the tolerance and the intended purpose of this tolerance. Whereas traditionally the tolerances between retaining screw and hole are as small as possible and intended merely for allowing the screw to pass, the tolerances provided (only for the neck of the screw, not the threaded part) according to the invention are intended for correcting misalignments. The combination envisaged in the present invention can be applied both for a temporary and/or a definite prosthesis.

According to a particular embodiment of the invention, the implant and prosthesis are further characterized in that the interface of the implant with the anchorage part of prosthesis comprises a flat-to-flat connection, further facilitating compensation for lateral misalignments upon fixing of the prosthesis to the implant or implant assembly with the retaining screw. Alternatively, the anchorage part of the prosthesis interlocks with the proximal end of the implant by way of dedicated features on the proximal surface of the prosthesis which form an interlocking structure, the dimensions of the configuration on the proximal end of the fixture head of the implant and the recess in the base or anchorage part of the prosthesis being adjusted to provide a tolerance appropriate for correcting misalignments (‘tolerance interlock’). Similarly, it is envisaged that such a tolerance is ensured whereby the male element is associated with the abutment. According to a particular embodiment, the configuration is a hexagonal protrusion on the proximal surface of the implant and the size of the protrusion is about 0.4 to about 1.2 mm smaller in diameter with respect to the corresponding hexagonal recess in the anchorage part of the prosthesis.

According to the present invention the implant can be a single structure, whereby the flat-to-flat or tolerance interlock connection is made at the interface (5) of the fixture head (6) of the implant and the proximal surface of the anchorage part of the prosthesis. Alternatively, the implant is referred to as an implant assembly, comprising an implant plus an abutment, screwed onto its proximal end. According to this embodiment, the flat-to-flat connection or tolerance interlock is between the proximal surface of the abutment and the anchorage part of the prosthesis.

According to the present invention the anchorage part of the prosthesis can either be a separate cylindrical component that can be incorporated into a prosthesis or be an integral part of the prosthesis.

Optionally, according to the present invention, the implant has an external (lateral) surface comprising a distal part (7) which is treated to interface with bone and a proximal part (8) which is untreated. According to a particular embodiment of the invention, the proximal part of the external surface has a length of between about 2 and about 6 mm.

According to a particular embodiment of the invention, the fixture head of the implant, which, at the interface of the implant with the prosthesis has a flat surface, further comprises in this flat surface one or more dedicated features to allow easy extraction of said implant after placement.

According to a further embodiment of the invention, the combination described above can further comprise an impression coping, which is also characterised in that it comprises an anchorage part with a proximal flat surface, in order to allow fixing to the implant and implant replica of the invention. Additionally or alternatively, the combination can further comprise an implant replica, equally characterised in that it comprises a proximal end which is a flat surface (9) for connection with the anchorage part of said prosthesis or said impression coping having a flat-surfaced anchorage part.

Alternatively, where the combination of implant and prosthesis described above is characterized by a tolerance interlock at its interface, the combination may further comprise an impression coping characterised by a dedicated recess or configuration which can interlock with the structure on the implant. According to a particular embodiment the interlock between the impression coping and the implant is not foreseen with a significant tolerance. Additionally or alternatively, according to this embodiment, the combination can further comprise an implant replica, equally characterized in that it comprises the dedicated features for interlocking with the prosthesis or impression coping. Again, for the implant replica, the dimensions of the dedicated features can either result in a tight interlock (little or no tolerance) or in a tolerance interlock with the impression coping and/or prosthesis.

Another aspect of the invention relates to an implant replica characterised in that it comprises a flat-surfaced proximal end (9) (i.e. a proximal surface which is flat) for connection with the anchorage part of a prosthesis or an impression coping having an anchorage part with a proximal flat surface. Alternatively, the implant replica is characterized in that it comprises the dedicated features for interlocking with the prosthesis or impression coping. The dimensions of the dedicated features can either result in a tight interlock (little or no tolerance) or in a tolerance interlock with the impression coping and/or prosthesis.

Optionally, this implant replica can comprise one or more flat indentations (10) on its external (lateral) surface for anchoring into a plaster cast and/or a tapered distal end (11) for insertion into a resin mould.

The implant replica according to the present invention further comprises in its proximal end an opening to an internal threaded hole (12) for introduction of a screw, by way of which an impression coping or prosthesis can be fixed to the implant replica. Thus, the size of the threaded hole of the implant replica will determine the size of the threaded screw shaft. According to a particular embodiment of the invention, the diameter of the opening and hole are the same size as or smaller than the diameter of the opening in the flat-surfaced anchorage part of said prosthesis or impression coping.

Another aspect of the invention relates to a retaining screw which can be used to fix a prosthesis or impression coping to an implant or implant assembly having at their interface a flat-to-flat or a tolerance interlock connection allowing compensation for lateral misalignments between the center of the anchorage part of the prosthesis and the center of the implant or implant assembly. This functional feature is preferably obtained by providing that the diameter of the neck (3) of the retaining screw is smaller than the hole in the anchorage part of the prosthesis (2). According to a particular embodiment, the diameter of its neck (3) is about 0.4 to 1.2 mm smaller with respect to the diameter of hole in the anchorage part of the prosthesis.

According to a particular embodiment of the invention, the retaining screw is further characterized in that it has a cylindrical head (13) with a conical opening inwards (14) to guide the screwdriver into position for screwing.

In order to ensure that the prosthesis or impression coping can be fixed tightly to the implant or implant assembly, the threaded shaft (15) should fit exactly into the threaded hole in the implant or implant assembly.

Another aspect of the invention relates to a centering screw for fixing a cylindrical component to the implant replica of the invention in the production of the prosthesis. This centering screw is characterised in that it has an externally tapered distal section (16) and a threaded shaft (17) which fits into the threaded hole (12) of the implant replica. According to a particular embodiment, the centering screw is further characterised in that the externally tapered distal section at its widest part has the same diameter as the inner diameter of the cylindrical component so that the tapered shape ensures centering of the screw with respect to the hole in the anchorage part of the implant replica.

Yet another aspect of the invention relates to an impression coping for taking an impression of an implant or implant assembly comprising a proximal end which has a flat surface (i.e. of which the proximal surface is flat), whereby the impression coping is also characterized in that it comprises an anchorage part (18) having a proximal flat surface.

Alternatively, the impression coping of the invention comprises at its proximal end a dedicated feature which enables it to interlock with an implant or implant assembly having corresponding features on its proximal end. According to a particular embodiment the dimensions of the dedicated features on the impression coping result in a tight interlock (little or no tolerance) with the implant or implant assembly.

Yet another aspect of the invention relates to a burn-out cylinder for connection to the implant replica of the invention, whereby the burn-out cylinder is characterized in that it comprises a proximal end (19) of which the proximal surface is flat. Alternatively, the burn-out cylinder is characterized in that it comprises the dedicated features for interlocking with the combination of the invention characterized by a tolerance interlock at its interface. According to a particular embodiment of the invention, the dimensions of the dedicated feature(s) result in a tight interlock (little or no tolerance) with the implant replica. A more particular embodiment relates to a burn-out cylinder, the proximal end of which is characterized by a hexagonal opening which interlocks with a hexagonal configuration in the implant replica.

Optionally, the burn-out cylinder of the invention can further comprises a tapered collar (20).

Yet another aspect of the invention relates to dedicated pick-up and conical impression coping screws for use in combination with an impression coping and implant or implant assembly of the invention, characterized in that the threaded shaft fits into the threaded hole in the implant or implant assembly. The choice between either screws allows impressions to be taken according to two kinds of techniques: pick up technique or conical impression coping technique. The advantage of the invention being that the same coping cylinder can be used.

Optionally, the above-described combination of dedicated implant, prosthesis and retaining screw optionally comprising a dedicated impression coping and implant replica, further comprises the centering screw, burn-out cylinder, pick-up and conical impression coping screws described hereinabove.

A further aspect of the invention relates to a dental implant with an incorporated abutment, comprising an externally threaded shaft and a non-threaded head (e.g. abutment) having a length of at least 2 mm, which sticks out of the bone upon introduction into the jaw.

Another aspect of the invention relates to a combination of an impression coping and an impression coping screw for fixing to a dental implant or implant replica, whereby the impression coping comprising an internal cylindrical hollow shaft and the impression coping screw comprises a threaded shaft having a diameter corresponding to the diameter of the cylindrical hollow shaft in the impression coping. The impression coping screw is further characterized in that it can have either a flat cylindrical head with a diameter that is exactly equal to that of the distal part of the coping or a bulbous head with a diameter which larger than that of the distal part of the coping. Optionally, the coping impression has a tapered external shape with a concave intrusion circumferentially along the external surface of its proximal part.

Another aspect of the invention relates to an implant holder with appropriate screw. The distal end of the implant holder comprises a flat surface (21) with a dedicated feature which by interlocking with the features on the implant of the invention, make it possible to extract the implant from the jaw in the event that this should be necessary. According to a particular embodiment this feature consists of two pins which fit into small holes at the proximal end of the implant.

### BRIEF DESCRIPTION OF THE FIGURES

The present description may be understood in conjunction with the accompanying Figures, incorporated herein by reference, in which:

FIG. 1: Schematic representation of A: prosthesis, B: retaining screw, C: fitting of retaining screw in the prosthesis and lateral movement; 1=anchorage part of prosthesis, 2=hole, 3=neck of retaining screw, 4=interface with implant, 13=head of retaining screw, 14=conical opening, 15=threaded shaft.

FIG. 2: Schematic representation of A: implant; B: implant replica, C: centering screw; 5=interface, 6=fixture head, 7=distal part of exterior surface of implant, 8=proximal part of exterior surface of implant, 9=proximal end of implant replica, 10=indentation, 11=distal end of implant replica, 12=internally threaded hole, 16=tapered distal section, 17=threaded shaft.

FIG. 3: Schematic representation of Impression coping (A) with conical impression coping (B) and pick-up (C) screws, Burn-out cylinder (D), screw (E); 18=Anchorage part of impression coping, 19=proximal end of burn-out cylinder, 20=tapered collar.

FIG. 4: Schematic representation of implant holder with screw.

FIG. 5: Schematic representation of a combination of prosthesis (A), implant (C) and retaining screw (B) wherein the interface between the prosthesis and implant is characterised by a tolerance interlock connection.

### DETAILED DESCRIPTION

The present invention relates to a system for a dental prosthesis whereby the fitting between the implant or implant assembly and the prosthesis provides a tolerance for misalignments. More particularly, the prosthesis is fixed to the implant by way of a retaining screw, which is passed through an opening (2) at the base or anchorage part (1) of the cylindrical component of the prosthesis, whereby the threaded shaft of the retaining screw is secured into a threaded internal bore in the implant. The diameter of the neck of the retaining screw (i.e. the part of the screw that is not threaded) (3) is smaller than the diameter of the opening or hole in the anchorage part of the prosthesis such that a lateral misalignment can be corrected when fixing the retaining screw in the fixture head of the implant post-operatively. The opening is preferably not larger than or equal in size to the head of the retaining screw. According to a particular embodiment, the difference in diameter between the neck of the retaining screw and the opening in the anchorage part of the prosthesis varies between about 0.4 and about 1.4 mm.

A specific embodiment of the invention relates to the above-described system further characterised by a flat-to-flat connection at the implant-to-prosthesis interface. The flat-to flat interface offers a number of advantages. Firstly it allows easier insertion of the prosthesis into the mouth than traditionally when the fixtures are angulated in opposite directions relative to each other. Secondly, there is a larger contact surface between the prosthesis (e.g. the cylindrical component in the prosthesis) and the fixture head of the implant which is believed to be beneficial towards preventing loosening of the screws retaining the prosthesis onto the implants. An increased surface area of contact provides an increased resistance through the transfer of forces from the surfaces of the temporary cylinder to the surface of the implant, reducing the strain placed on the fastening screw, micromovement and loosening of the screw.

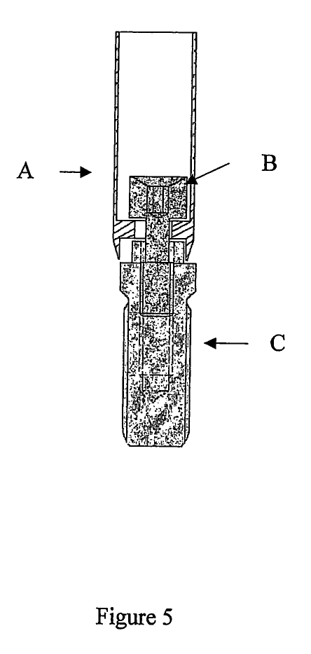

However, according to an alternative embodiment the tolerance of the implant-prosthesis fitting of the invention is ensured with an interface between implant and prosthesis based on interlocking features. Such a system of features on the fixture head of the implant and the proximal end of the prosthesis, which interlock but allow limited lateral movements is referred to herein as a ‘tolerance interlock’ interface. Such a tolerance interlock interface has the advantage that there is some guidance for the placement of the prosthesis to the adequate position on the implant, while at the same time tolerance for lateral movement upon fixing the prosthesis to the implant is ensured. According to a particular embodiment, the tolerance interlock allows lateral movements of about 0.4 to about 1.4 mm. According to a particular embodiment this is done by adjusting the size of the interlocking features (as illustrated in FIG. 5). This tolerance can be applied to different implant-prosthesis interlock designs described in the art, whereby either the implant and/or anchorage part of the prosthesis can comprise male and/or female structures. For instance, in the common configuration whereby a hexagon protrudes from the proximal end of the fixture and is received in a hexagonal recess in the base of the abutment or the implant itself, the size of the hexagonal protrusion according to the present invention is made smaller with regard to the hexagonal recess, allowing for lateral misalignments. More particularly, the diameter of the hexagonal protrusion is between about 0.4 and about 1.4 mm smaller than the diameter of the hexagonal recess.

The prosthesis of the present invention can be made in different ways. As the prosthesis is designed and manufactured by the dental lab, dedicated components are necessary. The invention is particularly suited for the immediate placement of a temporary prosthesis but can also be of interest for the fitting of a definite prosthesis to an implant. Alternatively, the definite prosthesis can be developed based on the exact location of the implants obtained from an impression thereof and the provision of the tolerance (between the hole in the anchorage part of the prosthesis and the neck of the retaining screw) for fixing the definite prosthesis to the implant is not necessary. Such a definite prosthesis will be characterized by either the flat-to-flat interface with the implant, or by the presence of one or more features ensuring an interlock (which is preferably tight) with the implant, depending on the embodiment of the invention.

A prosthesis can comprise a dedicated cylindrical component which is embedded into it. Such a component generally consist of one piece and can be rigidly incorporated into the prosthesis. According to the present invention, such a component has either a flat surface or comprises dedicated features allowing a tolerance interlock at the interface level with the fixture head of the implant. According to another embodiment of the invention, the suprastructure (i.e. the base structure of the prosthesis on which teeth will be provided) is manufactured using RP techniques such as CNC milling and Selective Laser Sintering. In this case, the interface is a proper part of the suprastucture's design and is not realized by incorporating a set of dedicated cylindrical components. At the proximal end or base of the component or the suprastructure of the prosthesis itself (also referred to as anchorage part (1)), an opening or hole (2) is provided through which the threaded end of a retaining screw can be fixed in the axial threaded hole in the implant.

The present invention is particularly suited for the development of a prosthesis in partial or complete edentuous cases, as for bridge-type prostheses the tolerance provided in the opening for the retaining screw will not compromise the stability of the prosthesis.

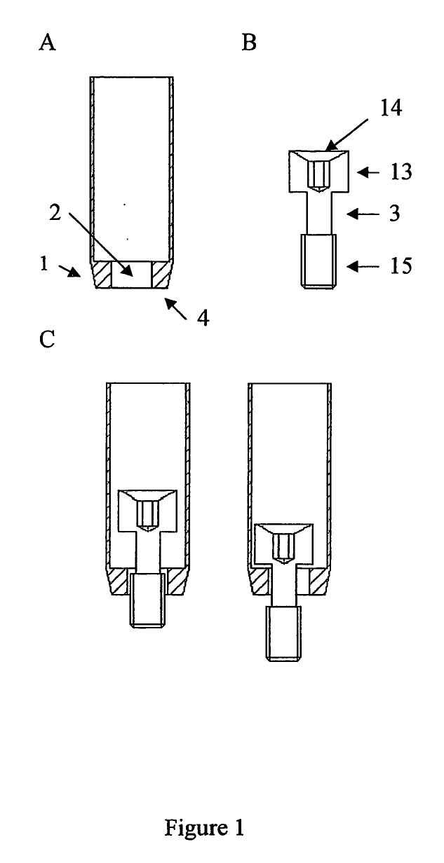

Thus, the present invention also relates to a dedicated retaining screw used for fixing the prosthesis to the implant of the present invention (FIG. 1B). A particular feature of the retaining screw is that the diameter of the neck of the retaining screw (3) is smaller than its threaded shaft (15). Misalignments will therefore be correct at the level of the neck of the retaining screws. According to a particular embodiment of the invention the retaining screw can further comprise a cylindrical head (13) with a conical opening (14) inwards to guide the screwdriver into position, increasing the ease-of-use of the system.

The present invention further provides screws which allow the centering of the cylindrical components with respect to the planned implant positions while manufacturing the prosthesis. The dental lab hereby starts from a model with implant replicas or analogues. On top of these the above mentioned cylindrical components are positioned, which are afterwards connected to each other in order to make up the framework of the prosthesis. To keep the cylindrical components in place during this process, dedicated centering screws are used. The ‘centering screws’ (FIG. 1C) have a screw thread at the distal end which fits through the opening in the bottom of the cylindrical component and into the implant replica. Above this thread, the centering screw widens gradually until its diameter corresponds exactly to the internal diameter of the cylindrical components. This results in a tapered lateral surface (17). A cylindrical portion (21) completes the design of the screw.

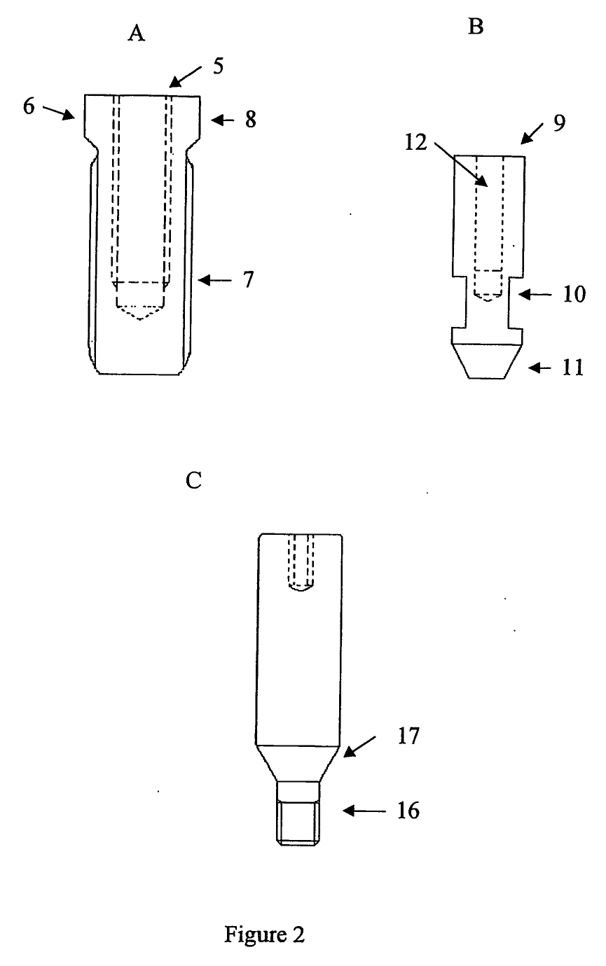

The invention further provides a dedicated implant, which comprises an elongate shaft having a proximal and distal end (FIG. 2A). An axial threaded internal bore extends from the proximal end. Contrary to traditional interfaces between implant and prosthesis (or the abutment and the prosthesis), the interface according to one embodiment of the present invention is characterised by the fact that the proximal surface of fixture head of the implant is flat and has no significant protruding parts or recesses to index with the prosthesis. Similarly, the proximal surface at the base of the anchorage part of the prosthesis is flat. Optionally, however, the fixture head of the implant can comprise one or more dedicated features allowing removal of the implant by way of an implant holder if necessary (see below). Such features however, should not disturb the flat-to-flat interface with the prosthesis. According to a particular embodiment, such features are a set of small holes, which can interlock with pins in the dedicated implant holder.

Alternatively, as described above, the interface between implant and prosthesis is characterised by a tolerance interlock, i.e. providing features which interlock with a tolerance for lateral misalignments.

The size/length of the implant does not matter. The concept of the invention can be applied to “standard” implants (from 7 mm to 230 mm) but can be extended to “long implants” (from 30 mm to 60 mm) for trans-sinusal use.

According to a particular embodiment of the invention, the interface between implant and prosthesis is made at the level of the gingiva, not of the bone. This is achieved by providing that the external surface of the implant comprises a proximal part having a smooth surface, e.g. a surface which is not threaded or treated to interface with bone. More particularly, this proximal part is extended from about 1 mm to about 2 mm or more. Thus, upon placement the implant, the fixture head is situated above the bone level, the smooth part of the implant being in the mucosa. The extension of this implant collar limits or eliminates the known problem (Bozkaya D. et al., Stress distribution Characteristics of Various implant Systems due to Non-Central Occlusal Loads, Northeastern Univ, Boston, http://wwwl.coe.neu.edu/˜smuftu/Dincer/comparison.pdf) of bone resorption in the area around the implant-abutment interface.

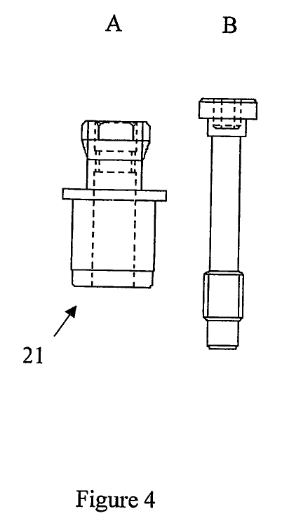

In order to allow insertion and extraction of the implant, a dedicated feature is optionally provided at the head of the fixture. This feature can be anything (a groove, a number of small intrusions, one or more flat surfaces on the side of the head of the fixture, etc.) allowing an appropriate tool to apply a torque on the head implant, thus screwing or unscrewing the implant. Such a tool for delivery of the implant to the surgical site and driving it into the osteotomy can in general be referred to as a fixture mount or implant holder (FIG. 4). It is attached to the implant by means of a screw. The fixture mount serves as an intermediate tool for transmitting to the implant the torque applied by the driving tool.

The present invention can be used to provide a prosthesis which can be placed on the implants immediately subsequent to surgery. This prosthesis can optionally be replaced with a final restoration after the implants have osseo-integrated, typically after 3 to 6 months. Given the design of the proximal end of the implant fixture head, dedicated components are necessary to allow the dental lab to manufacture the final restoration.

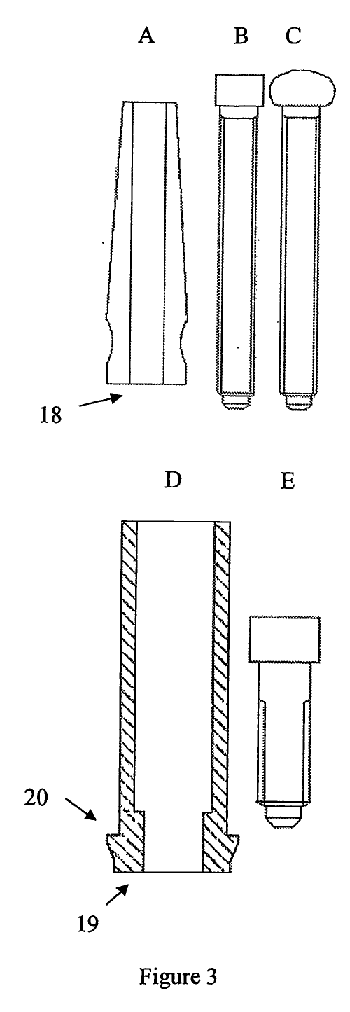

Thus, the invention further relates to dedicated components for making an impression. Traditionally, two types of impression copings are described: e.g. pick up impression copings and conical impression coping impression copings. The present invention provides a dedicated impression coping with two interchangeable impression coping screws (FIG. 3). Thus, the impression coping of the invention can be used as either one of the two traditional types of impression copings. The impression coping has a tapered external shape with a concave intrusion along its base circumference FIG. 3A). Along its longitudinal axis the coping has an internal cylindrical shaft through which the coping screws can be fixed either into an implant, for making the impression or, afterwards into an implant replica in the dental lab. When using the coping as a pick up impression coping, a coping screw is used having a flat cylindrical head with a diameter that is exactly equal to that of the top of the coping (FIG. 3B). After fixing the copings to the implants in the mouth of the patient, the impression material (such as silicon, poly-ether, vinyl polysiloxane or alginate) is applied to capture the shape of the jaw, and this material is allowed to harden. The coping screws are then removed providing the impression with the copings incorporated into it, yielding the exact location of the fixtures in the mouth. Alternatively, when the coping is used as a conical impression coping impression coping, a second type of screw is used, with a head shaped like an ellipsoid and a diameter larger than the width of the coping (FIG. 3C). In this case the copings stay on the implants when the impression is removed. In the dental lab, the copings are attached to implant replica's using the same, conical impression coping screws. Based on the marked external geometry of both the head of these screws and of the tapered copings with their distal intrusions, the impression can be repositioned on the copings accurately. The copings snap back in position because of the elasticity of the impression material.

Independent of how the impression coping of the present invention is used (as a pick up or conical impression coping), an impression is obtained that allows the positions of the fixture heads of the implants to be transferred to a plaster model, which then mimics the inside of the mouth of the patient. The model is used afterwards in the dental lab as the basis from which to design the restoration or prosthesis. Manufacturing the model is done by attaching replicas to the impression copings and subsequent casting in plaster.

The present invention further provides dedicated implant replicas (FIG. 2B) usable in conjunction with the described system and conceived as part of the invention. Similar to the implant, the proximal end of the implant replica comprises either a flat surface or a feature which allows interlocking with the prosthesis. According to a particular embodiment the feature on the implant replica ensures a tight interlock (no tolerance) with the prosthesis. According to a particular embodiment, this surface has a diameter equal to or slightly larger than that of the implant. Along its longitudinal axis the implant replica has an internally threaded bore with the same diameter as that in the implant. According to a particular embodiment, the replica has an overall cylindrical shape with the exception of a section near to its distal end which comprises one or more dedicated features (10) which allow anchoring into a plaster cast. According to a particular embodiment of the invention, these dedicated features are flat indentations. Alternatively—if a surgical planning is performed—the replica's can be inserted into a stereolithographic model of the jaw, which has predetermined holes corresponding to the planned positions of the implants. To avoid problems caused by resin residue clogging up at the bottom of these holes, the implant replica of the invention can be tapered over a length of one or more millimetres at its distal end (11).

A third component necessary in the dental lab for creating the final restoration is a burn-out cylinder (FIG. 3D). This component is fixed onto the replicas in the plaster model by means of wax up screws (FIG. 3E). It is used during the manufacturing process of the final restoration when the dental technician builds up a structure from a temporary material such as wax or acrylic which is afterwards cast in metal to obtain the frame of the final prosthesis. During casting the cylinder burns out, leaving a canal with the desired shape in the frame for the connection of the final prosthesis to the implant. For use in combination with the implant and implant replica of the present invention, the burn-out cylinder too, has an adapted shape. More specifically the proximal surface at the base of the cylinder is either a flat surface preferably equal in size to the surface of the implant fixture head or the base of the cylinder comprises a dedicated feature allowing the cylinder to be fixed to the implant replica. Optionally, a tapered collar ensures anchorage of the components in the metal cast. Moreover, the cylinder is hollowed out in two cylindrical sections. A first cylindrical section has a diameter equivalent to the head of the titanium screw (FIG. 3E) which will retain the prosthesis on the implant. The second section has a diameter equivalent to the neck of the screw. The screw is preferably a Ti screw. Tolerances are kept to a minimum i.e. for fitting purposes only.

Materials suitable for the production of the different components of the present invention are known to the skilled person and include different types of biocompatible metals and alloys thereof, more particularly gold and titanium (with optionally an oxidized or hydroxy-apatite treated surface) as well as bone-like ceramic material, bioglass, acrylic resin, and calcium phosphate.

### EXAMPLES

1. Implant Procedure and Provision of a (Temporary) Prosthesis

The position of the implants are planned using dedicated software involving computer tomography. A prosthesis is made pre-operatively around cylindrical components, having an anchorage part with a flat surface according to the invention, which are centered on the planned implant positions using centering screws.

The patient is then called in for surgery for implantation of the implants according to the predetermined positions, with the help of drill guiding templates. The implants used have a flat-surfaced fixture head. After the implants are positioned, the prosthesis is fixed on the implants using the retaining screw of the present invention, the flat-to-flat interface and the tolerance in the opening of the anchorage part of the cylindrical components of the prosthesis allowing for slight misalignments. Contrary to classical procedures the patient is provided with a prosthesis immediately subsequent to placement of the implants.

2. Fabrication of a Final Prosthesis

In case the previous procedure was used merely for the fabrication of a temporary prosthesis, the final restoration can be made as follows. First impression copings are placed on top of the implants in the mouth of the patient and fixed by means of pick-up or conical impression coping screws. Next, impression material is applied around the impression copings, on to the soft tissue and any still remaining teeth in order to register the intra-oral situation of the patient. After removal a mould is obtained with exact information about the positions of the implants—thanks to the impression copings imbedded in the impression materia—and about the level of the soft tissue. Implant replicas are screwed on the impression copings and a plaster cast is created using the mould. The plaster cast contains the implant replicas. After removal of the mould e.g. unscrewing the impression copings, burnout cylinders (features described earlier) are screwed onto the implants. The burnout cylinders are connected with wax and the suprastructure is designed based upon the expertise of the dental technician. Using the lost wax process a metal duplicate is made of the suprastructure, which is afterwards furnished and used as basis for the final prosthesis. Transfer of occlusion is done with the plaster casts mounted in an articulator. The cosmetic part of the restoration is made out of ceramic or resin. The restoration can be fixed in the mouth of the patient using with appropriate screws.

1-29. (canceled)

30. A combination of a dedicated dental implant or implant assembly, a prosthesis comprising an anchorage part (1) and a retaining screw, wherein said anchorage part (1) of said prosthesis comprises a hole (2) for said retaining screw, characterized in that the diameter of the neck (3) of said retaining screw is smaller than the diameter of said hole in said anchorage part of said prosthesis and further characterized in that the interface of said dedicated dental implant or implant assembly with said anchorage part of said prosthesis comprises a fiat-to-flat connection, so as to allow, upon fixing of said prosthesis to said dedicated dental implant or implant assembly with said retaining screw, compensation for lateral misalignments between the center of said anchorage part of said prosthesis and the center of said dedicated dental implant or implant assembly, by way of lateral movements of said prosthesis on said dedicated dental implant or implant assembly.

31. The combination of claim 30, wherein said compensation for lateral misalignments between the center of the anchorage part of the prosthesis and the center of the implant or implant assembly is ensured by way of lateral movements of the prosthesis on the implant of about 0.4 to about 1.4 mm.

32. The combination of claim 30, wherein the diameter of the neck (3) of the retaining screw is about 0.4 to 1.2 mm smaller with respect to the diameter of hole (2) in the anchorage part of the prosthesis.

33. The combination of claim 30, which is further characterized in that the diameter of the neck (3) of the retaining screw is smaller than its threaded shaft (15).

34. The combination of claim 30, characterized in that there is no tolerance between the threaded shaft (15) of the retaining screw and the hole (2) in the anchorage part (1) of the prosthesis.

35. The combination of claim 30, wherein the interface of said implant or implant assembly with the anchorage part of prosthesis is characterized by interlocking features which ensure a tolerance interlock, allowing, upon fixing of the prosthesis to the implant or implant assembly with the retaining screw, compensation for lateral misalignments between the center of the anchorage part (1) of the prosthesis and the center of the implant or implant assembly.

36. The combination of claim 30, wherein said anchorage part (1) is a separate cylindrical component that can be incorporated into a prosthesis.

37. The combination of claim 30, wherein said anchorage part (1) is integral part of the prosthesis.

38. The combination of claim 30, said implant comprising a fixture head (6), wherein said implant is a single structure and said flat-to-flat connection is between the proximal surface of said fixture head (6) of said implant and said proximal surface of said anchorage part (1) of the prosthesis.

39. The combination of claim 30, wherein said implant assembly comprises an abutment and said flat-to-flat connection is between the abutment and the anchorage part (1) of the prosthesis.

40. The combination of claim 30, wherein said implant has an external surface comprising a distal part (7) which is treated to interface with bone and a proximal part (8) which is untreated, characterised in that the proximal part has a length of between 2 and 6 mm.

41. The combination of claim 30, said implant comprising a fixture head (6), wherein said fixture head (6) of said implant at the interface (5) of said implant with the prosthesis having a flat surface, further comprises in said flat surface one or more dedicated features to allow easy extraction of said implant after placement.

42. The combination of claim 30, further comprising an impression coping which comprises an anchorage part with a proximal surface, characterised in that said proximal surface is flat.

43. The combination of claim 30, further comprising an implant replica, characterised in that said implant replica comprises a proximal end of which the proximal surface (9) is flat for connection with the anchorage part (1) of said prosthesis or with an impression coping having an anchorage part (18) with a proximal flat surface.

44. A retaining screw for fixing a prosthesis to a dental implant or implant assembly having at their interface a flat-to-flat connection or a tolerance interlock, said retaining screw being characterized in that the diameter of its neck (3) is smaller than its threaded shaft (15) and in that the diameter of its neck (3) is about 0.4 to 1.2 mm smaller with respect to the diameter of hole (2) in the anchorage part (1) of the prosthesis, so as to allow, upon fixing of the prosthesis to the implant or implant assembly, compensation for lateral misalignments between the center of the anchorage part of the prosthesis and the center of the implant or implant assembly.

45. The retaining screw of claim 44, further characterized in that it has a cylindrical head (13) with a conical opening inwards (14) to guide a screwdriver into position for screwing.

46. The retaining screw of claim 44, characterized in that the threaded shaft (15) fits into a threaded hole (2) in the implant or implant assembly.

47. The retaining screw of claim 44, characterized in that the diameter of the threaded shaft (15) of the retaining screw is equal to the diameter of the hole (2) in the anchorage part (1) of the prosthesis.

48. An impression coping for taking an impression of a dental implant or implant assembly comprising at its proximal end a flat surface, said impression coping comprising an anchorage part (18) having a flat surface.

49. A burn-out cylinder for connection to the implant replica comprising a flat-surfaced proximal end (9) for connection with the proximal flat surface of an anchorage part of a prosthesis or an impression coping, comprising a proximal end (19) which comprises a flat surface.

50. The burn-out cylinder of claim 49, which further comprises a tapered collar (20).

51. The burn-out cylinder of claim 49, further comprising an internal shaft comprising two cylindrical parts, wherein the diameter of proximal of said two parts is smaller than that of the distal part.
